(19) United States
(12) Patent Application Publication
(10) Pub. No.: US 2018/0120481 A1
(43) Pub. Date: May 3, 2018

(54) IMAGE CONCENTRATOR GRIN LENS SYSTEM

(71) Applicant: SPECTRUM OPTIX INC., Calgary (CA)

(72) Inventors: Darcy Daugela, Calgary (CA); John Daugela, Calgary (CA)

(21) Appl. No.: 15/795,145

(22) Filed: Oct. 26, 2017

Related U.S. Application Data
(60) Provisional application No. 62/413,682, filed on Oct. 27, 2016.

(51) Int. Cl. G02B 3/00; G02B 27/01

(52) U.S. Cl. CPC G02B 3/0087; G02B 2027/0116; G02B 27/0101

(57) ABSTRACT

A gradient index (GRIN) lens system includes: a first GRIN lens having a first surface and a second surface opposite to the first surface for refracting, in a first plane, incident light beams having an aspect ratio of x/y from an object from the first surface towards the second surface, the refracted incident light beams having an aspect ratio of x1/y; and a second GRIN lens having a first surface and a second surface opposite to the first surface for refracting, in a second plane, the refracted incident light beams from the first GRIN lens towards the second surface of the second GRIN lens to form a refracted image of the object with an aspect ratio of x1/y1.

### CROSS-REFERENCE TO RELATED APPLICATIONS

This patent application claims the benefit of U.S. Provisional Patent Application Ser. No. 62/413,682 filed on Oct. 27, 2016 and entitled “Image Concentrator Grin Lens,” the entire content of which is hereby expressly incorporated herein by reference.

### FIELD OF THE INVENTION

The disclosed invention generally relates to lens systems and more specifically, to an image concentrator gradient index (GRIN) lens system.

### BACKGROUND

Imaging devices such as cameras, microscopes and telescopes can be heavy and large. A large portion of this weight is due to the design of the optical lens elements, which can include heavy curved lenses, and the structure to support these lens separated by long focal distances. These imaging devices can be large (thick) mainly because in a typical lens system, the opening aperture to system device depth ratio is small. Moreover, to optically improve image resolution with the traditional lens systems, more device depth (longer focal length) is required in order to reduce lens refraction and minimize lens aberrations. The device depth of the imaging device can limit the imaging systems' performance and design. For example, the size and weight constraints of mobile, compact, or weight constrained imaging devices can limit resolution because they constrain the maximum focal length.

Additionally, conventional curved lenses have many different types of aberrations that reduce image resolution (spherical, coma, chromatic, and others). To correct these aberrations, conventional curved lenses use extra-large pieces of precision glass, adding weight, size and cost to the lens system.

A gradient index (GRIN) lens produces a gradual variation of the refractive index of a material. These gradual variations can be utilized to make lenses with flat surfaces, or lenses that do not have the aberrations typical of traditional lenses. GRIN lenses may have a refraction gradient that is spherical, axial, or radial.

The capability of GRIN lenses having flat surfaces simplifies the mounting and spacing of the lens. This is particularly useful where many small lenses need to be mounted together, such as, in photocopiers and scanners. The flat surface also allows a GRIN lens to be easily fused to an optical fiber, to produce collimated output. In imaging applications, GRIN lenses are mainly used to reduce aberrations. However, the design of such lenses involves detailed calculations of aberrations as well as efficient manufacture of the lenses. A number of different materials have been used for GRIN lenses including optical glasses, plastics, germanium, zinc selenide, and sodium chloride.

### SUMMARY

In some embodiments, the disclosed invention is a gradient index (GRIN) lens system that includes: a first GRIN lens having a first surface and a second surface opposite to the first surface for refracting, in a first plane, incident light beams having an aspect ratio of x/y from an object from the first surface towards the second surface, the refracted incident light beams having an aspect ratio of x1/y; and a second GRIN lens having a first surface and a second surface opposite to the first surface for refracting, in a second plane, the refracted incident light beams from the first GRIN lens towards the second surface of the second GRIN lens to form a refracted image of the object with an aspect ratio of x1/y1.

In some embodiments, the disclosed invention is a GRIN lens system that includes: an optical material for passing through incident light beams from an object; a first GRIN lens for refracting the incident light beams from the chromatic correction material, in a first plane; a second GRIN lens for refracting the refracted incident light beams from the first GRIN lens towards, in a second plane; and a focusing lens for focusing the refracted incident light beams from the second GRIN lens onto an image sensor or an eyepiece.

When herein x1/y1 is equal to x/y, it causes a refraction of the image of the object with the same aspect ratio. When x1 is smaller than x and y1 is smaller than y, the lens system compresses the image of the object, and when x1 is larger than x and y1 is smaller than y the lens system expands the image of the object.

In some embodiments, the first GRIN lens and the second GRIN lens are separate components. In some embodiments, the first GRIN lens and the second GRIN lens are combined in a single component. In some embodiments, the GRIN lens system may further include an electric energy source electrically coupled to one or both of the first and second GRIN lenses to dynamically change a refractive index of said one or both of the first and second GRIN lenses to refract the incident light beams at varying angles to minimize chromatic aberrations.

The GRIN lens system may be used in a telescope, a binocular, a microscope, a camera, and the like.

### BRIEF DESCRIPTION OF THE DRAWINGS

A more complete appreciation of the disclosed invention, and many of the attendant features and aspects thereof, will become more readily apparent as the disclosed invention becomes better understood by reference to the following detailed description when considered in conjunction with the accompanying drawings in which like reference symbols indicate like components.

FIG. 1 depicts near collimated light entering a lens with input width X and exiting with width Y1, according to some embodiments of the disclosed invention.

FIG. 2 shows that the GRIN concentrator lens output does not need to be orthogonal to the input to have a concentration effect, according to some embodiments of the disclosed invention.

FIG. 3 shows some embodiments of the GRIN concentrator lens where the angles of the GRIN surfaces are adjusted not be parallel, but still concentrate light and retain an image, according to some embodiments of the disclosed invention.

FIGS. 4, 5 and 6 illustrate the variables used in equations of FIG. 7.

FIG. 7 describes some equations that can be used to help design a simple GRIN concentrator lens without chromatic correction, according to some embodiments of the disclosed invention.

FIG. 8 shows concentration of image using GRIN refraction for some embodiment of a compact focusing lens system, according to some embodiments of the disclosed invention.

FIG. 9 is an exemplary 3D view of concentration of an image using two separate GRIN lenses, according to some embodiments of the disclosed invention.

FIG. 10 is an exemplary lens system for concentrating an image, according to some embodiments of the disclosed invention.

FIG. 11 is an exemplary lens system for concentrating an image including integrated focusing lens system and image sensor, according to some embodiments of the disclosed invention.

### DETAILED DESCRIPTION

Some embodiments of the disclosed invention are directed to an optical system including a gradient index element, for example a GRIN lens, to concentrate light in a compact form factor. One or more GRIN concentrator lenses can be used in the optical system to concentrate light in solar and energy concentration applications, and in imaging devices such as cameras, microscopes and telescopes to enable a more compact design. This optical system improves image quality by allowing a larger aperture to fit within a constrained space. In some embodiments, the disclosed invention uses a gradient index optical element to bend light through an angle Beta. A flat lens system is described in detail in U.S. patent application Ser. No. 15/222,058 entitled “Flat Wedge Shaped Lens And Image Processing Method,” (now, U.S. Pat. No. 9,759,900), the entire contents of which is hereby expressly incorporated by reference.

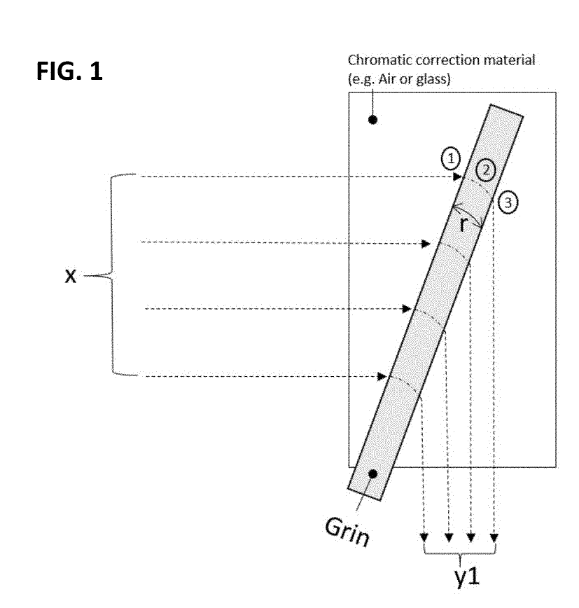

FIG. 1 depicts near collimated light entering a lens with input width X and exiting with width Y1. The ratio of X over Y1 defines the concentration factor in one plane. This way, the focusing lens system can be much smaller, for example, the size is reduced approximately by the concentration factor. Although, in this illustration, the lens is afocal, and requires another lens to focus light into an image, in some embodiments, one or more of the GRIN concentrator lens(s) may not be afocal. This way, the depth of the device (distance along the y axis), can be significantly less than the aperture size (distance along the x axis). This enables the creation of a compact optical lens system.

Multiple GRIN concentrator lenses can be used in a single optical system to further reduce the system size. In some embodiments, two GRIN concentrator lenses are positioned orthogonal to each other to concentrate light in two planes. Multiple GRIN concentrator lenses can be arranged to return the image to the desired aspect ratio, including the original aspect ratio.

In some embodiments, the disclosed invention reduces the chromatic aberrations through standard GRIN design techniques, using appropriate glass materials both before and after the GRIN element.

In some embodiments, the disclosed invention combines multiple GRIN concentrator lenses, and optionally the focusing lens system into one physical element. This has the advantage of significantly reducing the number of optical components, reducing cost, improving reliability and simplifying assembly.

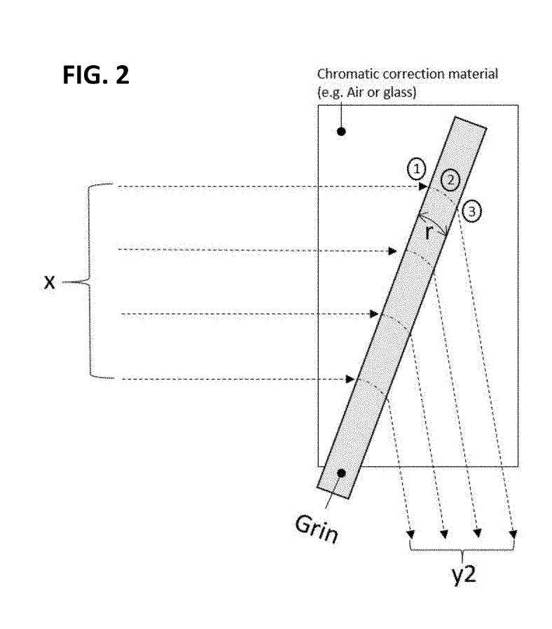

FIG. 2 shows that the GRIN concentrator lens output does not need to be orthogonal to the input to have a concentration effect. As depicted, due to less than 90 degree exit angle, the compression of this image is less that the one shown in FIG. 1, that is, Y2 in FIG. 2 is larger than Y1 in FIG. 1.

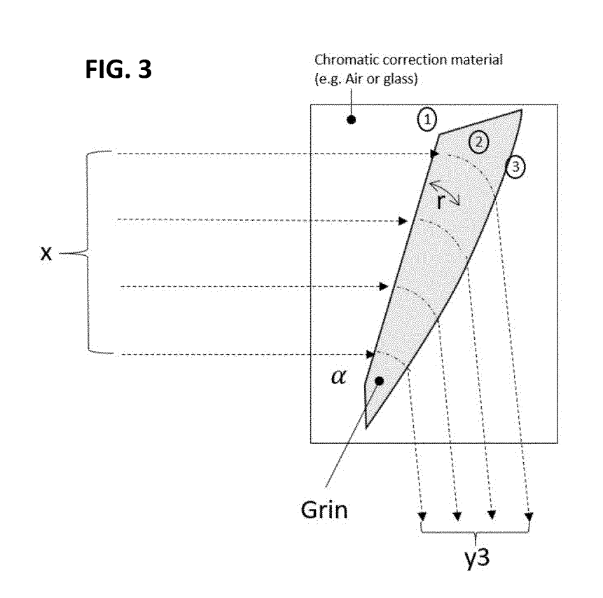

FIG. 3 shows some embodiments of the GRIN concentrator lens where the angles of the GRIN surfaces are adjusted in such a manner not to be parallel, but still concentrating light and retaining an image. This configuration is useful to add optical power to the front face (1) and/or rear face (2) of the lens to focus the light, assist with focusing light, and/or reduce optical aberrations that may occur across a wider field of view. This also enables a compact lens system that can both compress and focus light.

In some embodiments, the disclosed invention is scalable and applies to a full range of system sizes including those from small microscopic/nano to large telescopic systems greater than 30 m.

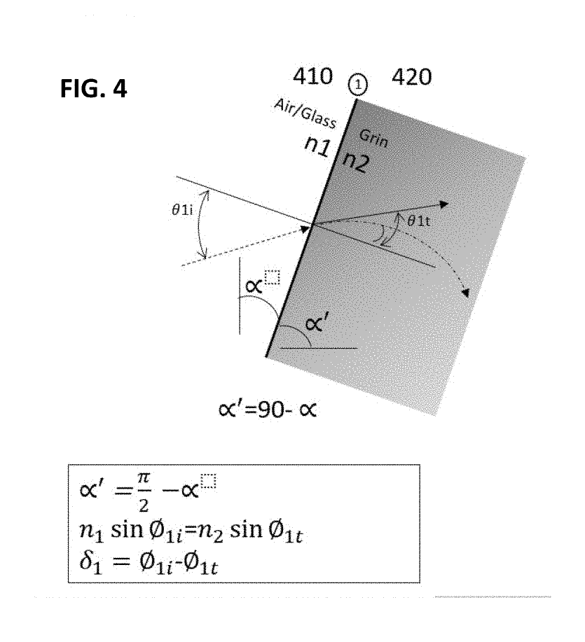

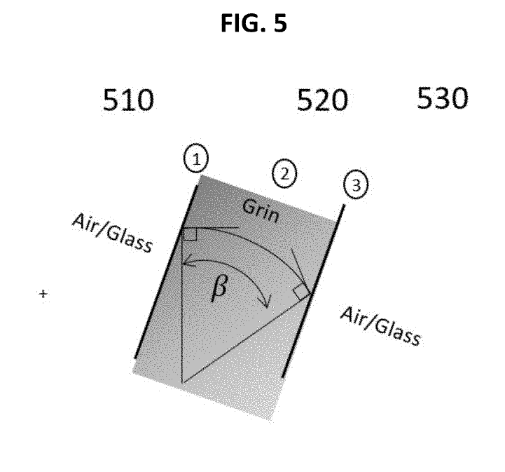

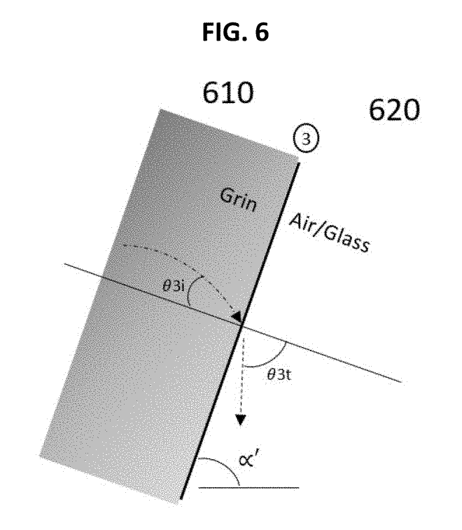

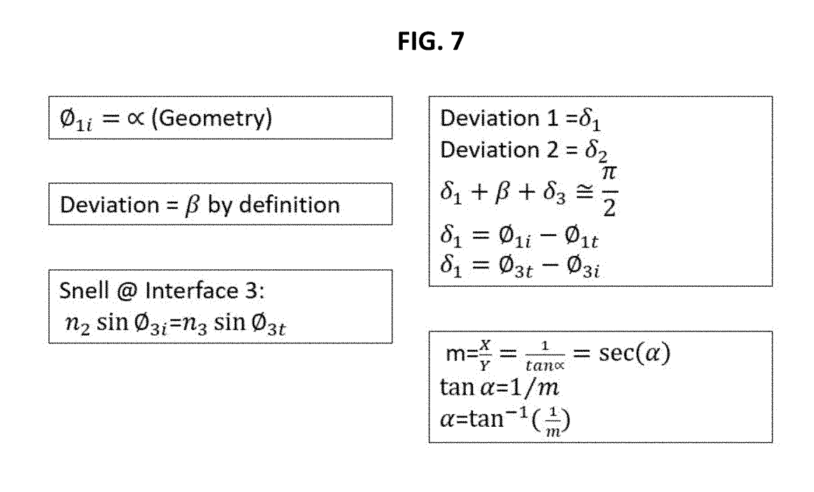

FIG. 7 describes some equations that can be used to help design a simple GRIN concentrator lens without chromatic correction, which can be used as a first approximation of the real design. FIGS. 4, 5 and 6 illustrate the variables used in these equations. A lens can be designed by specifying the total deviation of the light path (often approximately 90 degrees), and the magnification requirements (often between 2 and 5). Using the magnification, the angle alpha (α) can be determined. Using standard ray tracing formula (Snell's law), the total deviation of the GRIN light path, angle beta (β), required within the GRIN element can be determined. Standard GRIN design techniques based upon GRIN material properties and manufacturing techniques can be used to determine the GRIN dimensions.

The lens system can be made smaller by increasing the concentration ratio. However, the concentration ratio and image quality may be limited by chromatic aberrations, which may be corrected as described below. There are many options to reduce the chromatic aberrations of this design, including using multiple GRIN materials, and using glass elements before and after the GRIN element. Standard optical software simulators (such as Zemax™) can be used to make appropriate design tradeoffs to reduce chromatic aberrations.

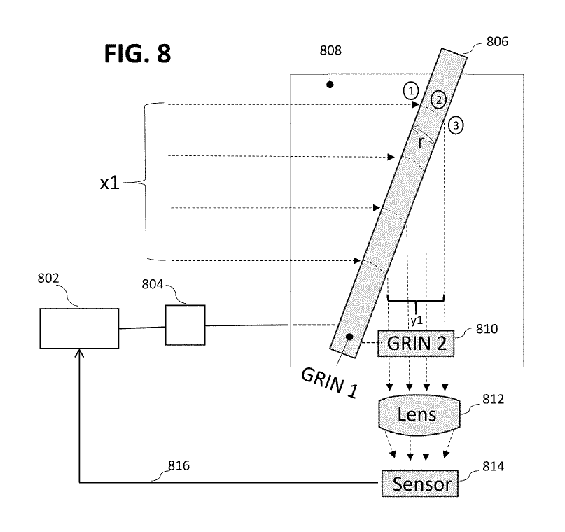

FIG. 8 shows concentration of image using GRIN refraction for some embodiment of a compact focusing lens system, according to the disclosed invention. As shown, an image with a size (width) of x1 enters the lens system. This image may pass through optional optical correction material 808, before it enters the lens system. The image is then refracted from an angled GRIN lens 806 (GRIN 1), as depicted. At location (interface) 1, the Snell's law dictates the refraction of the image. At location (interface) 2, the GRIN lens 806 internally refracts the light from the image in a curve or linearly. At location (interface) 3, Snell's law again dictates the refraction of the light from the image. Upon leaving the lens system, the image with size of x1 is now compressed in one plane with a size of y1, smaller than x1. The same process repeats itself with a second GRIN lens 810 (GRIN 2) to compress the (compressed) image in the another plane. The compressed image (in two planes) then enters a conventional lens system 812 (e.g., one or more lenses) that focus the image on one or more image sensor(s) 814 for capturing the image and optionally, further processing the captured image. In some embodiment, the compressed image is focused onto an eyepiece for viewing by a human.

In some embodiments, a known chromatic aberration measuring device or method may be used at the output of the lens system to measure the chromatic aberrations to provide feedback to a processor 802. For example, an image sensor(s) 814 may be augmented to have chromatic aberration measurement capabilities, or a separate device/method may be applied. The processor 802 in turn, controls a power supply 804 that varies electric field(s) or voltages applied to one or more of the optical components to change their refractive indices and thus vary the chromatic aberrations. This way, the processor-controlled system dynamically adjusts and minimizes the chromatic aberrations, without performing any complex conventional image processing.

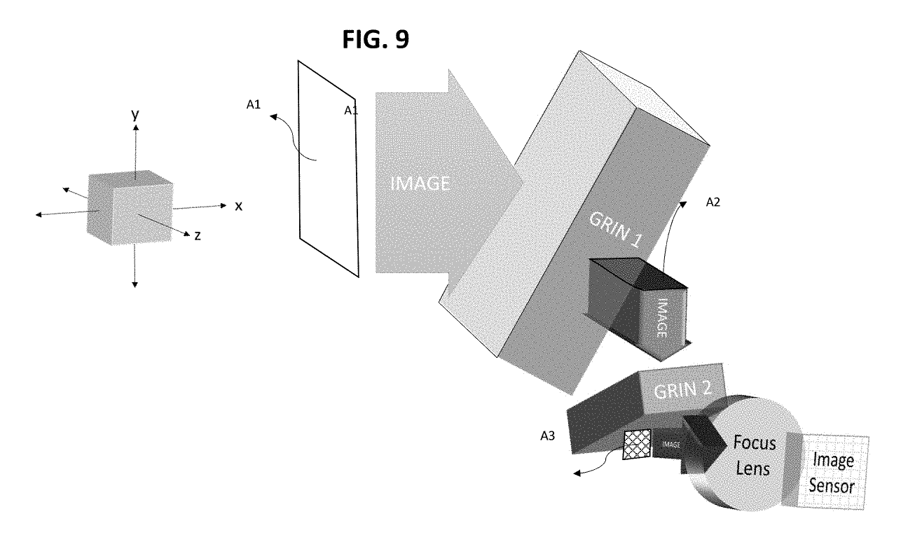

FIG. 9 is an exemplary 3D view of concentration of an image using two separate GRIN lenses (GRIN 1 and GRIN 2), according to some embodiments of the disclosed invention. As illustrated, an image with size (area) A1 enters the lens system from the left (x-axis). The image may pass through optional optical correction material, before it enters the lens system. The image then enters an angled first GRIN lens (GRIN 1), as shown. Variable/designed refraction occurs within GRIN1 lens. Upon exiting the GRIN 1 lens along y-axis, the image is compressed in an orthogonal plane resulting in an image area A2, which is smaller than the image area A1. The compressed image then enters a second GRIN lens (GRIN 2) and is compressed in a second plane, as described above. The image then exits GRIN 2 lens along z-axis creating an image area A3, which is smaller than the image area A2. By varying the variables of GRIN 1 and/or GRIN 2, this image can be constructed to its original aspect ratio by proportionally compressing the image in two (orthogonal) planes. The compressed image then enters a conventional lens system (one or more lenses, e.g., FOCUS LENS) that focus the image on an image sensor for capturing the image and optionally, further processing the captured image.

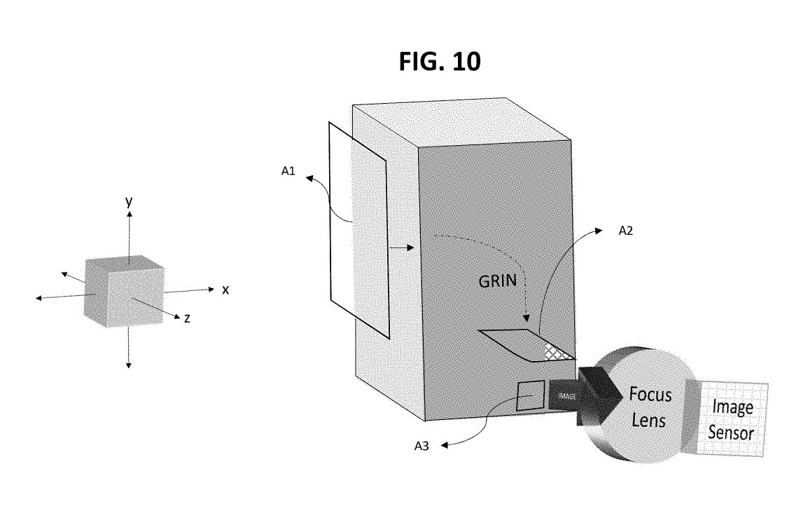

FIG. 10 is an exemplary lens system for concentrating an image, according to some embodiments of the disclosed invention. As shown, an image with an area A1 enters the lens system from the left (x-axis). The image may pass through optional optical correction material, before it enters the lens system. The image enters a GRIN lens (GRIN). This GRIN lens is equivalent to combining the GRIN 1 and GRIN 2 lenses in FIG. 9, enabling 2-plane compression in one GRIN lens since variable/designed refraction occurs within the single GRIN lens in two planes. The light path concentrates light on one axis (as it does for a single GRIN element shown in some earlier figures), then concentrates the light on another axis, and repeat this process until the desired concentration ratio and image aspect ratio is achieved. Since the light path of this combined single lens (GRIN 1 and GRIN 2 lenses) is the same (or substantially similar) to the two separate lens elements, this single lens can concentrate light in both planes.

The image then exits the GRIN lens along z-axis, creating a compressed image with an area A3 with in its original aspect ratio. The image then enters a conventional lens system (one or more lenses) that focus the image on an image sensor.

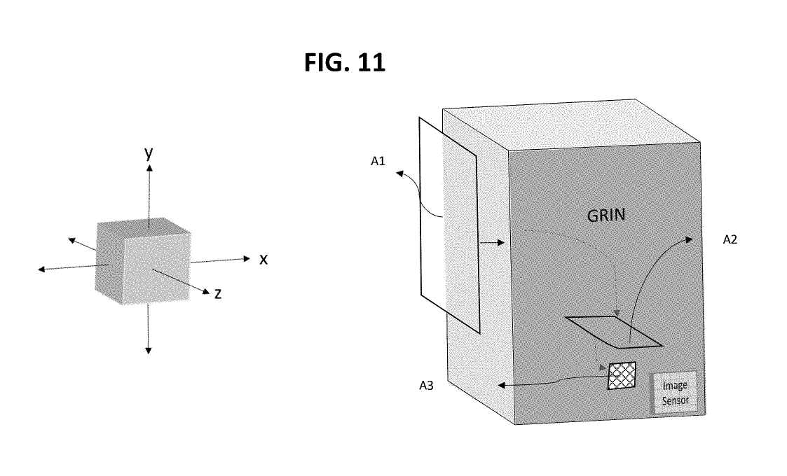

FIG. 11 is an exemplary lens system for concentrating an image including integrated focusing lens system and image sensor, according to some embodiments of the disclosed invention. In these embodiments, the focusing lens and the image sensor may be coupled or directly attached to the GRIN lens for a more compact and cost effective lens system. As shown, an image with a size A1 enters the lens system from the left (x-axis). The image may pass through optional optical correction material, before it enters the lens system. The image enters a GRIN lens. This GRIN lens is equivalent to combining the GRIN 1 and GRIN 2 and the focusing lenses in FIG. 9, enabling a 2-plane compression plus focusing in a single GRIN lens. Variable/designed refraction occurs within the single GRIN lens in two planes, and then the light is focused. The image exits the combined GRIN lens and focuses onto a focal plane. Some embodiments of this system include a focal plane coplanar with the GRIN lens surface so that an image sensor can be mounted onto the GRIN lens. This integrated lens system with mounted image sensor significantly reduces alignment time and costs and keeps the part count lower for manufacturing simplicity and cost.

The compressed image may then directed to an optional focusing lens to focus the compressed image onto one or more light sensor(s) (for example, CCD or CMOS sensor(s)). In some embodiments, as explained with respect to FIG. 2. of the U.S. Pat. No. 9,759,900, the focusing lens may focus the compressed image onto an eyepiece for viewing by a human. An image processor (implemented in software, hardware and/or firmware) corrects for any aberrations resulting from the lens system by using one or more image processing techniques. An example of correcting chromatic aberrations in hardware would be the use of one or more optical wedges and/or diffraction gratings, before the light sensor, that together have an achromatic effect for imaging. The refractive properties of the material of the GRIN lens(es) can be changed to assist in controlling chromatic dispersion for imaging applications as well. For example, the refractive index of the GRIN lens can be dynamically changed by applying voltage to current to the wedge comprised of certain material that refract the light differently under electric power.

Although, the lens system illustrated in FIGS. 9-11 do not show a processor, power supply and feedback loop (e.g., 802, 804 and 816 in FIG. 8), one skilled in the art would recognize that a known chromatic aberration measuring device or method may be used at the output of these lens systems to measure the chromatic aberrations to provide feedback to a processor, similar to those depicted in FIG. 8.

If the image processing is performed by an optical device (hardware), the correction is done before the image is received by the sensor. However, if the image processing is performed by software (executed on a processor), the corrections are performed after the image is received by the image sensor, that is, at the output of the sensor.

As explained in the U.S. Pat. No. 9,759,900, the radiation path (e.g., light path) may be reversed in the GRIN lens system of the present invention to expand, rather than compress, the original input image.

In some embodiments, the disclosed invention is capable of optical EM wave compression and/or expansion. Some applications for the flat (wedge) lens of the disclosed invention include both imaging and non-imaging applications. Examples of imaging applications are cameras (including those in mobile devices, such as mobile phones), microscopes, telescopes, binoculars, scopes, telecentric lenses, and the like. Examples of non-imaging applications are architectural light pipes, which could provide indoor illumination using natural light, and solar concentrators for more efficient solar energy generation.

It will be recognized by those skilled in the art that various modifications may be made to the illustrated and other embodiments of the disclosed invention described above, without departing from the broad inventive scope thereof. It will be understood therefore that the disclosed invention is not limited to the particular embodiments or arrangements disclosed, but is rather intended to cover any changes, adaptations or modifications which are within the scope of the disclosed invention as defined by the appended claims and drawings.

1. A gradient index (GRIN) lens system comprising:
a first GRIN lens having a first surface and a second surface opposite to the first surface for refracting, in a first plane, incident light beams having an aspect ratio of x/y from an object from the first surface towards the second surface, the refracted incident light beams having an aspect ratio of x1/y; and
a second GRIN lens having a first surface and a second surface opposite to the first surface for refracting, in a second plane, the refracted incident light beams from the first GRIN lens towards the second surface of the second GRIN lens to form a refracted image of the object with an aspect ratio of x1/y1.

2. The GRIN lens system of claim 1, further comprising an apparatus for processing the refracted image of the object to reduce chromatic aberrations.

3. The GRIN lens system of claim 1, wherein x1/y1 is equal to x/y causing a refraction of the image of the object with the same aspect ratio.

4. The GRIN lens system of claim 1, wherein x1 is smaller than x and y1 is smaller than y to compress the image of the object.

5. The GRIN lens system of claim 1, wherein x1 is larger than x and y1 is smaller than y to expand the image of the object.

6. The GRIN lens system of claim 1, further comprising a focusing lens to focus the refracted image of the object onto a sensor or an eyepiece.

7. The GRIN lens system of claim 2, wherein the apparatus for processing the image is an image processing device executing an image processing programming code to reduce said chromatic aberrations.

8. The GRIN lens system of claim 1, further comprising an optical correction material formed between the incident light beams and the first GRIN lens to reduce chromatic aberrations.

9. The GRIN lens system of claim 1, wherein the first GRIN lens and the second GRIN lens are separate components.

10. The GRIN lens system of claim 1, wherein the first GRIN lens and the second GRIN lens are combined in a single component.

11. The GRIN lens system of claim 1, further comprising an electric energy source electrically coupled to one or both of the first and second GRIN lenses to dynamically change a refractive index of said one or both of the first and second GRIN lenses to refract the incident light beams at varying angles to minimize chromatic aberrations.

12. The GRIN lens system of claim 11, further comprising a processor for controlling the electric energy of the electric energy source based on measured chromatic aberrations.

13. A telescope comprising the GRIN lens system of claim 4.

14. A binocular comprising the GRIN lens system of claim 4.

15. A microscope comprising the GRIN lens system of claim 5.

16. A camera comprising the GRIN lens system of claim 1.

17. The GRIN lens system of claim 1, wherein the first plane is orthogonal to the second plane.

18. A gradient index (GRIN) lens system comprising:
an optical material for passing through incident light beams from an object;
a first GRIN lens for refracting the incident light beams from the chromatic correction material, in a first plane;
a second GRIN lens for refracting the refracted incident light beams from the first GRIN lens towards, in a second plane; and
a focusing lens for focusing the refracted incident light beams from the second GRIN lens onto an image sensor or an eyepiece.

19. The GRIN lens system of claim 18, wherein the first GRIN lens, the second GRIN lens and the focusing lens are combined in a single component.

20. The GRIN lens system of claim 18, used in one or more of a telescope, a microscope, a camera and a binocular.
